(19) United States
(12) Patent Application Publication
(10) Pub. No.: US 2014/0345059 A1
(43) Pub. Date: Nov. 27, 2014

(54) ARRANGEMENT FOR ADJUSTING A BED, PARTICULARLY A HEAD SECTION AND FOOT SECTION OF THE BED, AS WELL AS DRIVE UNIT

(71) Applicant: LOGICDATA Electronic & Software Entwicklungs GmbH, Deutschlandsberg (AT)

(72) Inventors: Martin MELLBERG, Graz (AT); Haymo NIEDERKOFLER, Graz (AT); Daniel KOLLREIDER, Graz (AT); Walter Koch, Schwanberg (AT)

(73) Assignee: LOGICDATA Electronic & Software Entwicklungs GmbH, Deutschlandsberg (AT)

(21) Appl. No.: 14/181,561

(22) Filed: Feb. 14, 2014

(30) Foreign Application Priority Data
May 27, 2013 (DE) 102013105413.7

(51) Int. Cl. A61G 7/05; A61G 7/015

(52) U.S. Cl. CPC A61G 7/05; A61G 7/015
USPC 5/658

(57) ABSTRACT

An arrangement (AO) for adjusting a bed, particularly a head section and foot section of the bed, features a stationary frame segment (OR) and a movable frame segment (BR) with a first section (AS1), a second section (AS2) and a third section (AS3). The three sections (AS1, AS2, AS3) are pivotably connected to one another and the first section (AS1) is supported such that it can be slid relative to the stationary frame segment (OR) in a horizontal plane (HE). The arrangement (AO) features a first linear actuator (LA1) and a second linear actuator (LA2) that, on the one hand, are fixed on the first section (AS1) in an essentially rigid fashion in a common first hinge point (GP1) and, on the other hand, are respectively supported on the stationary frame segment (OR) in a horizontally slidable fashion such that the effective directions of both linear actuators (LA1, LA2) essentially extend in another common horizontal plane, particularly parallel to one another. The first linear actuator (LA1) is coupled to the second section (AS2) by means of a pivotably supported first brace (S1) and the second linear actuator (LA2) is coupled to the third section (AS3) by means of a pivotably supported second brace (S2) such that the second section (AS2) and/or the third section (AS3) can be pivoted.

### DESCRIPTION

The invention pertains to an arrangement for adjusting a bed, particularly a head section and foot section of the bed, that comprises a stationary frame segment and a movable frame segment. The arrangement furthermore features a first linear actuator and a second linear actuator. Furthermore, the invention pertains to a drive unit for use in the arrangement.

Beds and hospital beds with actuators, particularly linear actuators, that mechanically act upon a movable frame segment are known in many variations. For example, it is known to respectively equip a bed or hospital bed with one or more servomotors in order to transfer the head section or the foot section of the bed or the hospital bed from a flat sleeping position into an inclined position. Such actuators are usually controlled manually or semiautomatically by means of suitable control devices such as hand or foot switches.

The present invention is based on the objective of disclosing an arrangement for adjusting a bed, particularly a head section and foot section, as well as a drive unit for use in the arrangement, by means of which a simple and space-saving constructive design can be achieved.

This objective is attained with the features of the independent claims. Advantageous enhancements are defined in the dependent claims.

According to a first aspect, an arrangement is described that comprises a stationary frame segment and a movable frame segment with a first section, a second section and a third section, wherein the three sections are pivotably connected to one another, and the first section is supported such that it can be slid relative to the stationary frame segment in a horizontal plane. The arrangement furthermore comprises a first linear actuator and a second linear actuator that, on the one hand, are fixed on the first section in an essentially rigid fashion in a common first hinge point and, on the other hand, are respectively supported on the stationary frame segment in a horizontally slidable fashion such that the effective directions of both linear actuators essentially extend in another common horizontal plane, particularly parallel to one another. The first linear actuator is coupled to the second section by means of a pivotably supported first brace and the second linear actuator is coupled to the third section by means of a pivotably supported second brace such that the second section and/or the third section can be pivoted.

The first linear actuator and the second linear actuator can also be referred to as a drive unit or jointly form a drive unit.

The arrangement allows a compact and simple constructive design. The first and the second linear actuator, in particular, only occupy little structural space because both linear actuators are arranged in a common horizontal plane, particularly parallel to one another. Consequently, the effective directions of both linear actuators or their operating ranges also extend in only one horizontal plane and preferably parallel to one another. It is advantageous that no linear actuator is arranged in the vertical direction and no linear actuator acts in the vertical direction. The two linear actuators therefore only require little structural space and can be installed in a space-saving fashion in the region of the stationary frame segment. The linear actuators do not turn relative to one another, wherein the overall operating ranges of these linear actuators would otherwise be more extensive. Another advantage can be seen in that the linear actuators can be constructively designed and/or arranged in such a way that they are protected from unauthorized access. Furthermore, the bed can be realized in an altogether more compact fashion, i.e. the height of the entire bed, for example, can be reduced. In this way, the bed can also be realized, for example, with less weight, wherein this is particularly advantageous with respect to a hospital bed that needs to be moved manually by one person.

In an advantageous embodiment, the arrangement furthermore comprises a spring element that, on a first end, is coupled to the stationary frame segment and, on a second end, is coupled to the first brace and/or the first linear actuator in order to generate a spring force in an effective direction of the first linear actuator.

The spring element provides the advantage that energy can be stored in the spring element when the second section is pivoted by means of the first linear actuator, particularly when the second section is lowered into a horizontal recumbent position of the bed. This energy can be recovered when the second section is inclined such that the force required for inclining the second section does not have to be generated by the first linear actuator alone. In this way, the actuator itself can be realized more economically, i.e. particularly smaller and less massive. In addition, the power supply of the first and/or second linear actuator, as well as their motor controls, can also be realized smaller and more economically. Another advantage is that the additional assistance of the spring element promotes the self-locking effect of the movable frame. The movable frame particularly cannot move by itself under a load such as, for example, the weight of a person. Without the spring element, the weight or the load of the movable frame, particularly the second and/or third section, would respectively have to be absorbed and compensated by the actuators only. This load can be at least partially compensated by providing the spring element. Primarily shock-like or impulsive loads that are caused, for example, by an abrupt movement of a person therefore can be absorbed particularly well and largely do not lead to damages or unnecessary wear of the linear actuators.

For example, the spring element may be rigidly fixed, particularly preinstalled, on the stationary frame segment. The spring element may alternatively also be preinstalled on the drive unit, particularly the first linear actuator.

According to another advantageous embodiment, the second section is supported on the first section such that it can be pivoted about a second hinge point and the first brace is supported on the second section such that it can be pivoted about a third hinge point, wherein the second hinge point and the third hinge point are spaced apart from one another by a short distance, particularly less than 300 mm. This makes it possible to achieve a steep angle of inclination of the second section relative to the horizontal plane with a short travel of the first linear actuator. A high kinematic transmission ratio can therefore be realized. The shorter the distance between the second hinge point and the third hinge point, the less favorable the lever ratios become, such that higher moments of force and loads act upon the first linear actuator and the first linear actuator therefore needs to generate higher forces in order to pivot or hold the second section in position. However, the high forces acting upon the first linear actuator can be significantly reduced by providing the spring element.

According to another advantageous embodiment, the spring element is substantially pretensioned when the second section is pivoted into a lower angular range with reference to the horizontal plane, particularly below 20°. Due to the kinematic design of the movable frame, the highest forces act upon the first linear actuator, in particular in this lower angular range, such that the highest forces need to be generated by the first linear actuator in this range as already described above. The spring element is provided, in particular, for assisting the first linear actuator in this angular range and decisively reduces the forces to be generated by the linear actuator.

According to another advantageous embodiment, the spring element comprises a coil spring. A simple and economical design of the spring element is therefore disclosed.

According to another advantageous embodiment, the first linear actuator, the second linear actuator and/or the first section are respectively supported on the stationary frame segment in a guide mechanism, particularly a slide rail, in a horizontally slidable fashion. Such a guide mechanism may consist, for example, of a C-profile. Consequently, a simple constructive measure for slidably supporting the two linear actuators and/or the first section on the stationary frame segment is disclosed.

According to another advantageous embodiment, the movable frame segment comprises a holding rack that is designed such that a mattress can be inserted or arranged in the holding rack in such a way that a center plane of the mattress is essentially arranged in the plane of the pivoting axes of the pivotably connected sections of the movable frame segment and the mattress is bent in the center plane, particularly in a neutral axis, during a pivoting motion of the second section and/or the third section.

In this case, the center plane corresponds to a plane that essentially extends parallel and offset to a sleeping surface of the mattress, particularly at a height of half the mattress thickness.

Bending occurs in the mattress when the head section and/or foot section is raised and lowered. If the bending takes place around a pivot point that lies underneath the mattress, the mattress is subjected to a compression in the upper region, i.e., essentially only compressive stresses occur. This means that the mattress becomes shorter in the upper surface section. If the pivot point is shifted into the neutral axis, particularly into the center plane of the mattress, the mattress is subjected to a compression (compressive stress) in the upper surface section and to an elongation (tensile stress) in the lower surface section. In this way, deformations are created due to stresses that are respectively cut in half in comparison with compressive stresses only. This increases the service life of the mattress by reducing the deformation. In addition, the comfort during an adjustment of the bed is improved. When the sleeping surface is deformed, a relative motion between the body of a person and the sleeping surface inevitably occurs, wherein this relative motion is minimized in the above-described fashion.

The first brace and/or the second brace preferably feature a tension-compression rod. Consequently, a simple and economical option for realizing the first and/or second brace is disclosed, wherein the tension-compression rod has such a constructive design that tensile forces, as well as compressive forces, can be absorbed.

According to another advantageous embodiment, the second section is a head section of the bed and the third section is a foot section of the bed. Consequently, the head section of the bed and the foot section of the bed can be respectively adjusted by means of the first and the second linear actuators.

According to another advantageous embodiment, a housing that comprises motors and/or electronics for driving the two linear actuators is fixed on the first section in the region of the first hinge point. In this way, the motors or the two linear actuators can respectively be compactly arranged in one housing. This saves additional structural space. For example, a common housing may be provided for both linear actuators and may comprise the electronics, for example control electronics, and the motors of the two linear actuators. Consequently, both linear actuators can be jointly installed in a simple fashion such that the costs and the time required for the installation are reduced. A single housing also has the advantage that less material is required, wherein this once again leads to cost savings, as well as weight advantages.

According to a second aspect, a drive unit for use in an arrangement according to the first aspect is described, wherein said drive unit comprises a first linear actuator and a second linear actuator. The two linear actuators are fixed in a common housing in such a way that the effective directions of both linear actuators extend in a common horizontal plane, particularly parallel to one another. The two linear actuators are designed to be fixed in an essentially rigid fashion in a common first hinge point on a first section of a movable frame segment.

The drive unit essentially has the above-described advantages.

Other advantageous designs of the invention are described in greater detail below with reference to embodiment examples that are illustrated in the figures. In these figures, identical components are identified by the same reference symbols. Characteristics that have already been described with the aid of reference symbols are not necessarily provided with reference symbols in all figures.

In these figures:

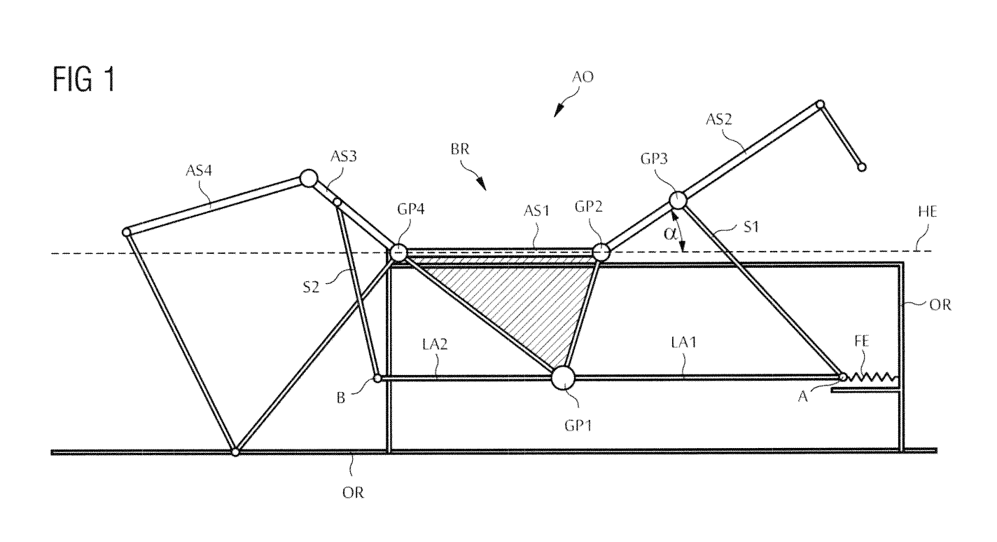

FIG. 1 shows a first schematic two-dimensional view of an arrangement for adjusting a bed,

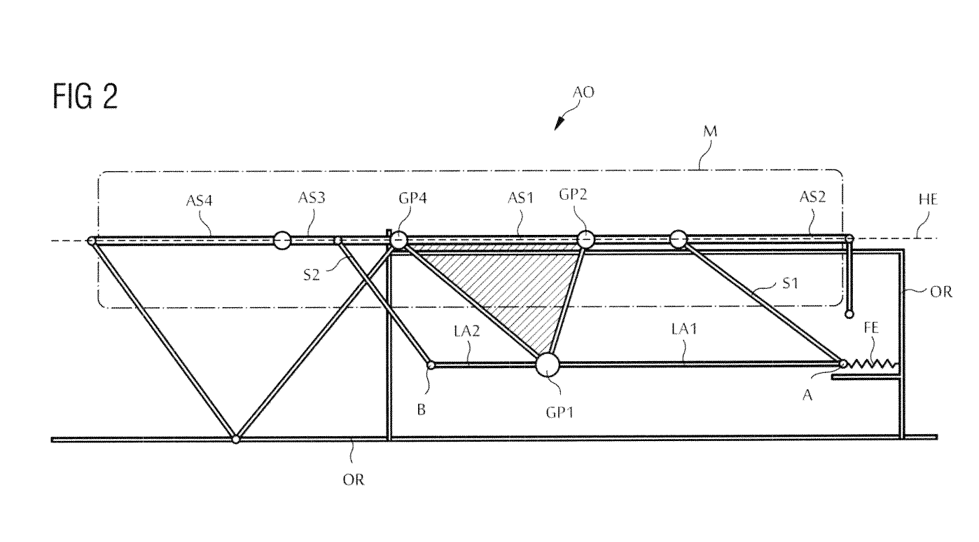

FIG. 2 shows a second schematic two-dimensional view of the arrangement,

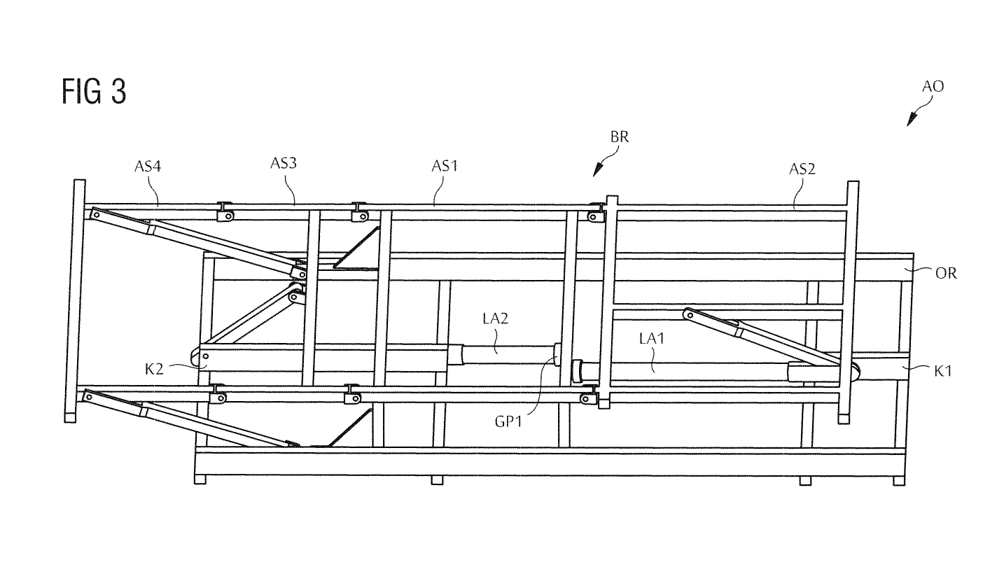

FIG. 3 shows a first perspective view of the arrangement,

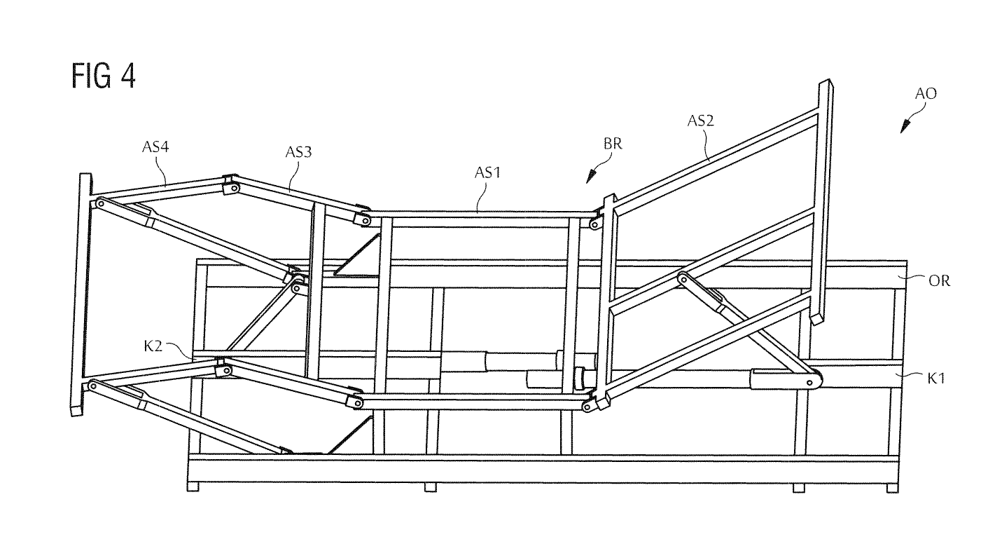

FIG. 4 shows a second perspective view of the arrangement,

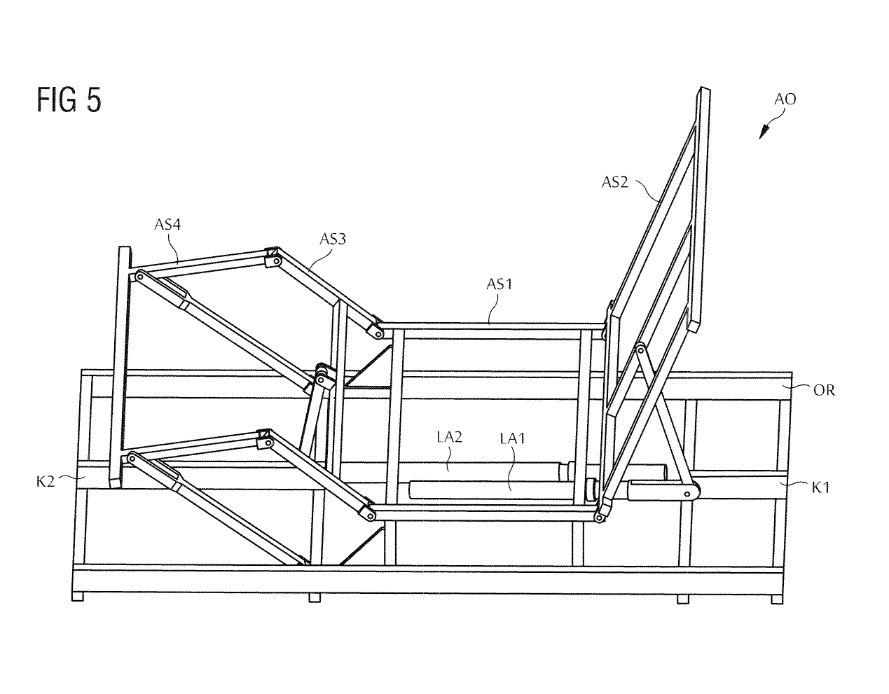

FIG. 5 shows a third perspective view of the arrangement,

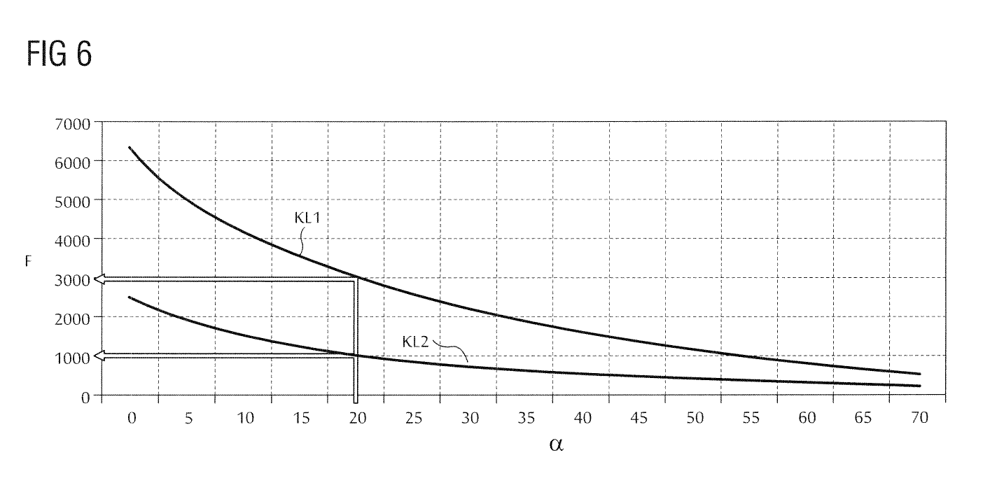

FIG. 6 shows a schematic diagram for elucidating a force of a linear actuator in dependence on an angle,

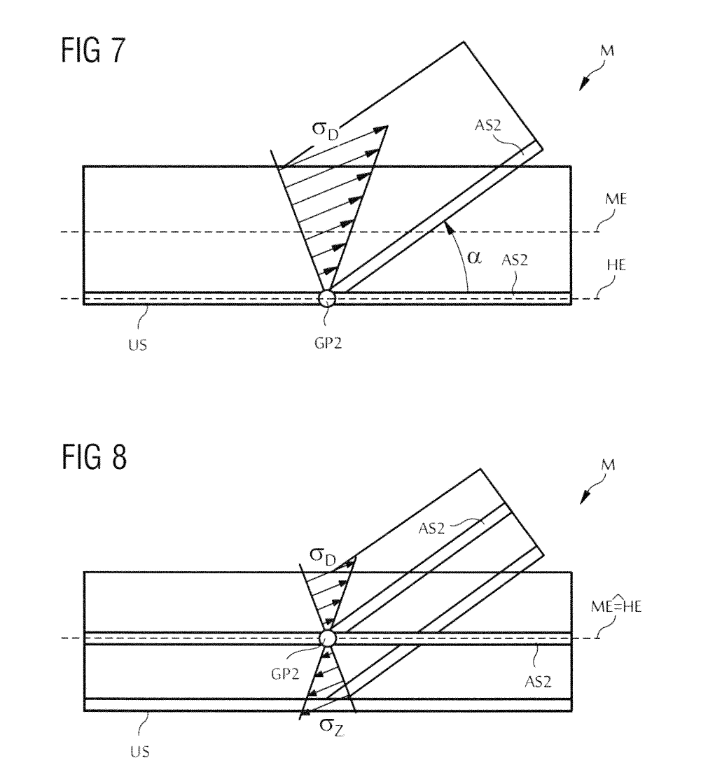

FIG. 7 shows a first schematic view of a load on a mattress, and

FIG. 8 shows a second schematic view of a load on the mattress.

FIGS. 1 and 2 show two schematic two-dimensional views of an arrangement AO for adjusting a bed, particularly a head section and foot section of the bed. In this case, FIGS. 1 and 2 respectively show a kinematic model that describes a kinematic position of the arrangement. The constructive design and dimensioning illustrated, for example, in FIGS. 3-5 is irrelevant in this case. Only the kinematic principle of the arrangement AO is important.

The arrangement AO features a stationary frame segment OR and a movable frame segment BR. The movable frame segment BR is divided into several sections that are pivotably connected to one another, particularly by means of hinges. The movable frame segment BR features a first section AS1 that is supported such that it can be slid relative to the stationary frame segment OR in a horizontal plane HE extending perpendicular to the plane of projection in FIG. 1. The first section may be supported, for example, by means of a guide mechanism. The first section AS1 may be supported, for example, in a slide rail that has a C-profile. The movable frame segment BR furthermore features a second section AS2 and a third section AS3. The movable frame segment additionally features a fourth section AS4 that represents a lowering of the feet.

A first linear actuator LA1 and a second linear actuator LA2 are fixed in an essentially rigid fashion in a first hinge point GP1 of the first section AS1 of the movable frame segment BR. The two linear actuators LA1 and LA2 can also be referred to as a drive unit or jointly form a drive unit. The first linear actuator LA1 is furthermore supported in a horizontally slidable fashion on the stationary frame segment OR in the point A. The second linear actuator LA2 is supported in a horizontally slidable fashion in the point B on the stationary frame segment (not shown). The horizontal support of the two linear actuators LA1 and LA2 in the points A and B may also be realized by means of a guide mechanism, particularly by means of a slide rail, for example, analogous to the first section AS1. It is important to note that the points A and B refer to points, particularly kinematic points of application, of the linear actuators LA1 and LA2, particularly in end regions of the linear actuators LA1 and LA2. The first linear actuator LA1 and the second linear actuator LA2 lie in a horizontal plane that extends parallel and offset to the horizontal plane HE, wherein the effective directions extend parallel to one another. This means that the points B and A can be respectively shifted relative to one another and relative to the first hinge point GP1.

The second section AS2 is supported on the first section AS1 such that it can be pivoted about a second hinge point GP2. The second section AS2 respectively represents the head section of the movable frame segment BR or of a bed. The second section AS2 is coupled to the first linear actuator LA1 by means of a first brace S1 that is pivotably supported on the second section AS2 in a third hinge point GP3. The brace S1 is pivotably supported on the first linear actuator LA1, for example, in the point A. However, the first brace S1 may also be pivotably supported on the first linear actuator LA1 at a different location.

If the distance between the first hinge point GP1 and the point A is now reduced by means of the first linear actuator LA1, i.e., if the extension of the first linear actuator is reduced, the second section AS2 is pivoted about the second hinge point GP2 in such a way that an angle of inclination α relative to the horizontal plane HE is increased. The second section AS2 or the head section is therefore respectively inclined. The second section AS2 is lowered if the distance between the point GP1 and the point A is increased by means of the first linear actuator.

This applies analogously to the third section AS3 that represents a foot section of the bed. The third section AS3 is supported such that it can be pivoted relative to the first section AS1 about a fourth hinge point GP4. The third section AS3 is pivotably supported on the second linear actuator LA2 by means of a second brace S2. The second brace S2 is pivotably supported on the second linear actuator LA2, for example, in the point B. However, the second brace S2 may also be pivotably supported on the second linear actuator LA2 at a different location.

If the distance between the point B and the first hinge point GP1 is now reduced or increased by means of the second linear actuator LA2, i.e., if an extension of the second linear actuator is changed, the third section AS3 is pivoted relative to the horizontal plane HE. A pivoting motion of the third section AS3 simultaneously causes a pivoting motion of the fourth section AS4 that is pivotably supported on the third section AS3. Consequently, the foot section of a bed can be adjusted by means of the second linear actuator LA2. In this case, the third section AS3 and the fourth section AS4 are pivoted out of the horizontal plane HE in opposite angular rotating directions (in the clockwise direction and in the counterclockwise direction).

In the embodiment example, the first linear actuator LA1 and/or the first brace S1 are mechanically coupled to a spring element FE that is fixed on the stationary frame segment OR. It would alternatively also be possible to dispense with the spring element FE. The spring element FE serves as a spring energy store, particularly when lowering the second section AS2 of the movable frame segment BR, and is realized in the form of a coil spring. Other spring designs are conceivable and familiar to a person skilled in the art. Since the first linear actuator LA1 is mechanically connected to the first section AS1, the first section AS1 is slid when the first linear actuator LA1 is actuated. If the distance between the first hinge point GP1 and the point A is increased, the first section AS1 moves toward the left in the horizontal plane HE.

A stop is provided on the stationary frame segment OR in order to limit this motion toward the left. In the embodiment example according to FIG. 1, the stop is arranged on the stationary frame segment OR in the region of the fourth hinge point GP4. If the extension of the first linear actuator LA1 is now increased in order to lower the second section AS2, the first section AS1 is slid toward the left (in the plane of projection of FIG. 1) up to the stop. In this state, the second section AS2 is still pivoted out of the horizontal plane HE as illustrated in FIG. 1. If the distance between the first hinge point GP1 and the point A is now additionally increased, the spring element FE is compressed and therefore pretensioned. In this case, the spring element FE is pretensioned until the second section AS2 coincides with the horizontal plane HE. Energy is stored in the spring element during this process. The arrangement AO is preferably dimensioned in such a way that the spring energy store or the spring element FE is substantially pretensioned starting at an angle a of less than 20°, i.e., in a lower angular range.

The energy stored in the spring element FE is utilized or recovered when the second section AS2 is inclined. Since the highest forces act upon the first linear actuator LA1 in the lower angular range, the first linear actuator LA1 can now be relieved with the aid of the spring element FE. If the distance between the first hinge point GP1 and the point A is reduced, the spring element FE exerts a spring force in the direction of the first linear actuator LA1 and assists this linear actuator in generating the forces for respectively inclining or pivoting the second section AS2.

The force to be generated by or the power of the first linear actuator LA1 can be reduced with the aid of the spring element FE. Consequently, the power supply of the first linear actuator and even the motor control can also be realized smaller and more economically. The first linear actuator LA1 itself can also be realized more cost-efficiently, for example with a weaker rating. Another advantage of the spring element FE is achieved in that the self-locking effect of the movable frame segment BR is promoted. The movable frame segment BR essentially cannot move by itself under a load such as, for example, the weight of a person lying on the bed. For example, if the person transfers into an upright position or moves on the movable frame segment BR, forces can be generated that would be directly transmitted to the first linear actuator LA1 via the first brace S1 if no spring element FE is provided. These forces can now be partially absorbed by the spring element FE such that the movable frame segment is essentially not moved. This also reduces the wear of the first linear actuator LA1.

Another advantage of the spring element FE can be seen in the fact that a short distance can be realized between the second hinge point GP2 and the third hinge point GP3. The shorter the distance between the second hinge point GP2 and the third hinge point GP3, the higher the respective forces or moments of force that are transmitted to the first linear actuator LA1 that need to be compensated or generated by this first linear actuator. However, a short distance between the second hinge point GP2 and the third hinge point GP3 also means that a steep angle of inclination α can be realized with a short travel of the first linear actuator LA1. A high kinematic transmission ratio can therefore be achieved. The high forces and/or moments of force can be (at least partially) compensated by the spring element FE as described above such that a short distance between the second hinge point GP2 and the third hinge point GP3 and a high kinematic transmission ratio can be respectively realized. The distance between the second hinge point GP2 and the third hinge point GP3 should preferably be shorter than 300 mm, wherein said distance may alternatively also be longer or significantly shorter.

A second spring element may be additionally or alternatively provided for assisting the second linear actuator LA2, wherein this second spring element is arranged on the stationary frame segment OR analogous to the spring element FE that serves for assisting the first linear actuator LA1. Such a spring element would reduce the forces to be generated by the second linear actuator LA2 in order to pivot the third section AS3.

The spring element FE and/or a second spring element may form part of the stationary frame segment OR or part of the drive unit. This means that the spring element FE may be permanently preinstalled on the stationary frame segment OR and mechanically coupled to the drive unit, particularly to the first linear actuator, during its installation.

Vice versa, it would also be conceivable to permanently preinstall the spring element FE on the drive unit, i.e. the first linear actuator LA1. In this way, the drive unit can be manufactured separately and supplied to a customer or installer. The drive unit can therefore be used modularly, i.e. it can be used in different arrangements. In this case, the arrangements do not necessarily have to be realized in accordance with the arrangements AO illustrated in the figures.

The arrangement AO according to FIG. 1 shows the two linear actuators LA1 and LA2 that are arranged in a common horizontal plane extending parallel to the horizontal plane HE. Due to this horizontal arrangement, the structural space can be optimally utilized, i.e. in a space-saving and compact fashion. If one of the two linear actuators LA1 and LA2 were to be arranged, for example, perpendicular to the horizontal plane HE, a significantly larger structural space would be required. All in all, the arrangement AO therefore can be dimensioned smaller. In addition, the two linear actuators LA1 and LA2 may be arranged, for example, relatively close to the floor such that they are protected from access by unauthorized persons.

Due to the fact that the two linear actuators LA1 and LA2 are rigidly connected to the first section AS1 in the first hinge point GP1, the motors of the linear actuators and/or electronics such as, for example, control electronics may be accommodated in a common (overall) housing. The electronics and the motors therefore are integrated into the housing. The housing is fixed on the first section AS1 of the movable frame segment BR in the first hinge point GP1. This also saves structural space and contributes to the compact design of the arrangement AO. In addition, the common housing can be completely installed on the first section AS1 in one installation step, so that the installation time and the costs are reduced. All in all, the housing requires less material than several housings such as, for example, separate housings for the electronics and/or for the motors of the two linear actuators. This saves material costs and manufacturing costs. Cable runs, for example, can also be installed more easily in this way and protected, for example, from tensile stresses caused by relative motions between the movable frame segment BR and the stationary frame segment OR.

In FIG. 2, the arrangement AO is illustrated in a recumbent position of the bed. In this case, the second section, the third section and the fourth section AS2, AS3 and AS4 are pivoted in such a way that they lie in the horizontal plane HE. The spring element FE is pretensioned in this position. The first section AS1 is engaged with the stationary frame segment OR by means of the above-described stop. The distance between the point B and the first hinge point GP1 is reduced in comparison with FIG. 1. The distance between the first hinge point GP1 and the point A is increased in comparison with FIG. 1. In this respect, it is important to note that FIGS. 1 and 2 are not drawn true-to-scale and should merely be interpreted as examples.

FIGS. 3-5 show three kinematic positions of the arrangement AO in the form of perspective views. The arrangement AO according to FIGS. 3-5 shows a bed or bed frame, the constructive design of which is realized in accordance with the kinematic model of the arrangement AO described with reference to FIGS. 1 and 2. In this respect, it is important to note that this merely concerns one possible constructive design of the described kinematic model. The movable frame segment BR and the stationary frame segment OR may also have a different constructive design. The arrangements AO according to FIGS. 3-5 feature the spring element FE that, however, is not shown. The spring element FE is arranged and/or fixed on the stationary frame segment OR in the region of a guide mechanism K1.

FIG. 3 shows the arrangement AO in a recumbent position of the bed. FIG. 4 shows the arrangement AO with a slightly inclined second section AS2 and slightly inclined sections AS3 and AS4. In FIG. 5, the arrangement AO is illustrated in a substantially inclined position. FIGS. 3-5 show that the two linear actuators LA1 and LA2 are arranged in a common horizontal plane, wherein their effective directions extend parallel to one another. The two linear actuators LA1 and LA2 are connected to the first section AS1 in an essentially rigid fashion in the first hinge point GP1. Since the two linear actuators LA1 and LA2 are additionally guided in guide mechanisms K1 and K2, the two linear actuators LA1 and LA2 do not necessarily have to be rigidly and permanently connected to the first section AS1 of the movable frame segment BR in the first hinge point GP1.

FIG. 6 shows a schematic diagram in which a force to be generated by the first linear actuator LA1 is plotted as a function of the angle of inclination α of the second section AS2. This diagram shows a first characteristic KL1 and a second characteristic KL2, wherein the characteristic KL1 corresponds to a distance between the second hinge point GP2 and the third hinge point GP3 that is shorter than a distance corresponding to the characteristic KL2. The diagram shows that the force of the first linear actuator LA1 substantially increases in a lower angular range below approximately 20°. The forces can amount to around 6000 N in a very low angular range below 3°, particularly when the second hinge point GP2 and the third hinge point GP3 are spaced apart by a short distance. These forces can be at least partially reduced by providing the spring element FE. The first linear actuator LA1 therefore can be decisively relieved. Among other things, this reduces the wear of the first linear actuator LA1.

FIGS. 7 and 8 show a schematic cross section through part of a mattress M. For example, the mattress M is designed for being pivoted by means of an arrangement AO according to the preceding figures. In this case, it is irrelevant whether this concerns a mattress M in the form of a cushioned supporting surface that is rigidly connected to the arrangement AO or a removable mattress M. Bending occurs in the mattress M when the second section AS2 (head section) and/or the third section AS3 (foot section) is raised and lowered.

FIG. 7 shows the tensions that occur within the mattress M when the mattress M is arranged or installed on the arrangement AO in such a way that the underside US of the mattress M extends in the horizontal plane HE. The mattress M has a center plane ME that extends through the mattress M, parallel and offset to the underside US. In FIG. 7, the center plane ME is not congruent with the horizontal plane HE. For example, if the second section AS2 is now inclined into a pivoted position about the second hinge point GP2 by an angle of inclination α, the mattress M is compressed in the upper region. This means that the mattress M is substantially shortened in the upper surface section. Only compressive stresses σD essentially occur in this case. Consequently, the mattress M is significantly stressed, primarily in the upper region of the upper surface section, such that the service life of the mattress M is reduced.

The arrangement AO illustrated in FIGS. 1-5 now makes it possible to arrange a holding rack on the movable frame segment BR, wherein said holding rack is realized in such a way that the mattress M can be arranged or fixed thereon. In this case, the holding rack is designed in such a way that the center plane of the mattress M coincides with the horizontal plane HE of the arrangement AO. This is also schematically illustrated in FIG. 2. If the second section AS2 is now pivoted, for example, not only compressive stresses σD occur, but also tensile stresses σZ. This is caused by the second hinge point GP2 being situated at the height of the center plane ME of the mattress M. The mattress M is therefore bent about the second hinge point GP2. Consequently, the compressive stresses σD occurring in the upper region of the mattress M are cut in half in comparison with the compressive stresses σD in FIG. 7. The tensile stresses σZ occurring in the lower region of the mattress are likewise cut in half in comparison with the compressive stresses according to FIG. 7. The mattress M is therefore bent in a neutral axis or neutral bending line. In this way, the deformation of the mattress M is reduced in comparison with FIG. 7. This extends the service life of the mattress and also improves the comfort during adjustments of the bed. When the sleeping surface of the mattress M is deformed, a relative motion between a body and the sleeping surface inevitably occurs, wherein said relative motion is minimized in the above-described fashion.

What is claimed is:

1. An arrangement for adjusting a bed, particularly a head section and foot section of the bed, comprising:
a stationary frame segment and a movable frame segment with a first section, a second section and a third section, wherein the three sections are pivotably connected to one another, and the first section is supported such that it can be slid relative to the stationary frame segment in a horizontal plane; and
a first linear actuator and a second linear actuator that are fixed on the first section in an essentially rigid fashion in a common first hinge point and are respectively supported on the stationary frame segment in a horizontally slidable fashion such that the directions of action of both linear actuators essentially extend in another common horizontal plane, particularly parallel to one another,
wherein the first linear actuator is coupled to the second section by means of a pivotably supported first brace and the second linear actuator is coupled to the third section by means of a pivotably supported second brace such that the second section and/or the third section can be pivoted.

2. The arrangement according to claim 1, further comprising:
a spring element that, on the a first end, is coupled to the stationary frame segment and, on a second end, is coupled to the first brace or the first linear actuator in order to generate a spring force in an effective direction of the first linear actuator.

3. The arrangement according to claim 1, wherein the second section is supported on the first section such that it can be pivoted about a second hinge point, and the first brace is supported on the second section such that it can be pivoted about a third hinge point, and wherein the second hinge point and the third hinge point are spaced apart from one another by a short distance, particularly less than 300 mm.

4. The arrangement according to claim 2, wherein the spring element is substantially pretensioned when the second section is pivoted into a lower angular range referred to the horizontal plane, particularly below 20°.

5. The arrangement according to claim 2, wherein the spring element comprises a coil spring.

6. The arrangement according to claim 1, wherein the first linear actuator, the second linear actuator or the first section are respectively supported on the stationary frame segment in a guide mechanism, particularly a slide rail, in a horizontally slidable fashion.

7. The arrangement according to claim 1, wherein the movable frame segment comprises a holding rack that is designed such that a mattress can be arranged or fixed on the holding rack in such a way that a center plane of the mattress is essentially arranged in the plane of the pivoting axis of the pivotably connected sections of the movable frame segment, and wherein the mattress is bent in the center plane, particularly in a neutral axis, during a pivoting motion of the second section or the third section.

8. The arrangement according to claim 1, wherein the second section is a head section of the bed and the third section is a foot section of the bed.

9. The arrangement according to claim 1, wherein a housing that comprises motors or electronics for driving the two linear actuators is fixed on the first section in the region of the first hinge point.

10. A drive unit for use in an arrangement according to claim 1, comprising:
a first linear actuator and a second linear actuator that are fixed in a common housing in such a way that the effective directions of both linear actuators extend in a common horizontal plane, particularly parallel to one another, and wherein the two linear actuators are designed for being fixed in an essentially rigid fashion in a common first hinge point on a first section of a movable frame segment.

11. The drive unit according to claim 10, further comprising:
electronics for actuating motors of the first and the second linear actuators, wherein the electronics are arranged in the common housing.
